(19) United States
(12) Patent Application Publication
(10) Pub. No.: US 2015/0264189 A1
(43) Pub. Date: Sep. 17, 2015

(54) SYSTEM AND METHOD FOR TELECOMMUNICATIONS EXPENSE MANAGEMENT

(71) Applicants: GARETH MORGAN, TORONTO (CA); HEATHER MORGAN, TORONTO (CA); MIKE WEATHERBEE, TORONTO (CA)

(72) Inventors: GARETH MORGAN, TORONTO (CA); HEATHER MORGAN, TORONTO (CA); MIKE WEATHERBEE, TORONTO (CA)

(21) Appl. No.: 14/644,533

(22) Filed: Mar. 11, 2015

Related U.S. Application Data
(60) Provisional application No. 61/951,317, filed on Mar. 11, 2014.

(51) Int. Cl. H04M 15/00

(52) U.S. Cl. CPC H04M 15/80

(57) ABSTRACT

Systems and methods for managing telecommunications services expenses are provided. For example, the system may have at least one module configured to receive one or more data sets containing account and plan information for one or more end users; at least one module configured to analyze the one or more data sets containing account and plan information to generate a set of recommendations; at least one module configured to solicit offers from one or more third party suppliers and one or more telecommunications services providers; and at least one module configured to provide an interface to display the one or more data sets containing account information, plan information, and recommendations, wherein the at least one module is also configured to receive instructions from an enterprise client or an end user.

### CROSS REFERENCE TO RELATED APPLICATION

This application claims priority to U.S. Provisional Application No. 61/951,317 filed Mar. 11, 2014, the entire contents of which is hereby incorporated by reference.

### FIELD

This invention relates generally to expense management systems, and more particularly to systems and methods for managing expenses incurred for telecommunications services.

### BACKGROUND

At the present time, significant effort, time and expense are expended to manage issues arising from the provisioning and delivery of telecommunications services.

Telecommunications services include the sale and provisioning of telecommunications related hardware; hardware support; telephony services; mobile content services; mobile Internet services; broadband Internet services; landline services; television services; among others.

Stakeholder groups for these services include telecommunications services providers, third party suppliers, enterprise clients and end users. Enterprise clients are organizations that negotiate with telecommunications service providers to provide services to groups of end users whose accounts may be managed by the enterprise client. Telecommunications service providers may provide services directly to end users or indirectly through the enterprise clients to the end users. Third party suppliers may provide services such as hardware support and hardware sales.

For example, XYZ Wireless Corp., a telecommunications services provider, could provide services to Joe Smith on an individual basis, and/or through his employer, ABC Corp. If the services are through the enterprise client, ABC Corp., Joe's account could be managed along with the accounts of ABC's other employees by an administrator at ABC Corp. Joe may also have simultaneously both personal accounts (which would be provided directly by the XYZ Wireless Corp.) and work accounts (which would be provided by XYZ Wireless Corp. But managed by ABC Corp.). In further example, ABC Corp. may also purchase its handsets through a third party supplier, DEF Phones, who then provides the physical devices and support plans for ABC Corp.

Each of the stakeholder groups are affected by significant and different issues that arise from the complexity of delivering a varied set of telecommunications services to a large number of end users, each with different service needs and price expectations.

For example, telecommunications services providers often contend with dissatisfied clients and end users who may demand prices of services which cannot be granted by the provider due to existing pricing and service policies. As a result, these enterprise clients and end users may switch telecommunications services providers based on their perception that the telecommunications services provider has a low quality of service or confusing customer service experience, tactics and processes. Further, the telecommunications services providers also may have issues with internal miscommunication or misinformation when marketing or implementing telecommunications services.

On the side of the enterprise clients and end users, high and unnecessary costs for telecommunication services may be incurred as the service plans in place do not fit the usage patterns or price expectations of the end users. Many organizations and individuals have a limited understanding of prices to pay for services and often cannot benchmark to understand what a reasonable price to pay should be. As a result, many enterprises have spent significant resources and staff to manage their telecommunications services needs, including both their needs for hardware (such as mobile phones, modems, mobile wireless devices, etc.) and their needs for services (such as telephony, voicemail, roaming, data, long distance, etc.). This management of telecommunications services needs is further complicated by poor records keeping; miscommunications between business groups; fragmented expense and billing policies; changes in usage patterns; timing issues in receiving billing information; among others.

These issues and more have led to disagreements between telecommunications service providers, enterprise clients and end users; uncertainty about whether price and plan negotiations are fair; and high costs related to service plans that are out of alignment with usage patterns of end users. Telecommunications services providers have thus received a large number of complaints from unsatisfied customers, for issues ranging from improper billing to poor customer service.

While some telecommunications service providers have provided a rudimentary set of tools for end users to manage their telecommunications services usage, such as the My Rogers/Business Self-Serve platform provided by Rogers Wireless, problems described above continue to persist as these sets of tools are designed primarily to serve the needs of the telecommunications services providers. The tools are limited in the scope of their ability to modify existing services and provide only basic invoice and usage information and reporting.

There exists a need for a new solution for overcoming one or more shortfalls of the products currently in the market, or at least an alternative.

### SUMMARY

The present disclosure relates to systems and methods for providing a platform for managing expenses incurred for telecommunications services.

In an embodiment, there is provided a system for receiving, parsing, storing, analyzing and displaying information related to telecommunications services. The system may have at least one data storage device storing one or more data sets and a processor configured to interact with an enterprise client or an end user device for data and control command exchange, where the processor may provide:
at least one module configured to receive one or more data sets containing account and plan information for one or more end users;
at least one module configured to analyze the one or more data sets containing account and plan information to generate a set of recommendations;
at least one module configured to solicit offers from one or more third party suppliers and one or more telecommunications services providers; and
at least one module configured to provide an interface to display the one or more data sets containing account information, plan information, and recommendations, the interface also configured to receive instructions from an enterprise client or an end user device.

In another aspect, the system further comprising at least one module to monitor changes in account information or plan information.

In another aspect, the system further comprising at least one module to electronically communicate changes in telecommunications services to a telecommunications services provider.

In another aspect, the system wherein the at least one module configured to provide an interface to display the one or more data sets and to receive instructions includes a web portal.

In another aspect, the system wherein the at least one module configured to provide an interface to display the one or more data sets and to receive instructions includes a mobile application.

In another aspect, the system wherein the mobile application is configured to determine whether an end user's mobile device is roaming, and if the device is roaming, apply a set of instructions to the mobile device.

In another aspect, the system wherein the mobile application is configured to receive charge information for costs to be passed on to a third party.

In another aspect, the system wherein the at least one module is configured to receive one or more data sets containing account information receives information by interfacing with a telecommunications services provider's backend systems.

In another aspect, the system wherein the at least one module is configured to receive one or more data sets containing account information receives information by interfacing with a telecommunications services provider's web portal.

In an embodiment, there is provided a method for receiving, parsing, storing, analyzing and displaying information related to telecommunications services. The method may involve at least one data storage device and at least one processor, and may implement various operations such as:
receiving one or more data sets containing account and plan information for one or more end users;
processing the one or more data sets containing account and plan information to generate a set of recommendations;
transmitting electronic notifications to solicit offers from one or more third party suppliers and one or more telecommunications services providers; and
providing an interface on a display device of the one or more data sets containing account information, plan information, and recommendations, the interface also configured to receive instructions from an enterprise client or an end user.

In another aspect, the method may further involve monitoring changes in account information or plan information.

In another aspect, the method may further involve electronically communicating changes in telecommunications services to a telecommunications services provider.

In another aspect, the method may further involve providing an interface on the display device to display the one or more data sets and to receive electronic instructions includes a web portal.

In another aspect, the method may further involve providing an interface to display the one or more data sets and receiving instructions using a mobile application.

In another aspect, the method may further involve configuring a mobile application to determine whether an end user's mobile device is roaming, and if the device is roaming, apply a set of instructions to control operation of the mobile device.

In another aspect, the method may further involve configuring the mobile application to receive charge information for costs to be passed on to a third party.

In another aspect, the method may further involve receiving one or more data sets containing account information receives information by interfacing with a telecommunications services provider's backend systems.

In another aspect, the method may further involve receiving one or more data sets containing account information receives information by interfacing with a telecommunications services provider's web portal.

In another embodiment, there is provided a method for automatically onboarding data for an end user device and period data collection: receiving data sets defining data related to telecommunication services; collating and parsing the data sets to extract plan, usage and cost data for telecommunication services; populating a data storage device with the plan, usage and cost data; processing and analyzing information using decision rules managed by a rules engine processor to determine cost savings by identifying irregularities and cost overages; automatically negotiating for offers by comparing one or more received electronic offers for telecommunications services to existing services to automatically generate recommendations; transmitting notification of selected telecommunications services based on the recommendations; and electronically monitoring the implementation of selected telecommunications services by collecting and processing additional data sets for the telecommunications services.

In another embodiment, there is provided a backend server platform to manage telecommunications services and expenses that interfaces one or more telecommunications services providers, one or more end user devices, one or more enterprise clients, and one or more third party dealers. The server platform may have: an information receiving module that receives electronic data sets in the form of costs, accounts and plan for telecommunications services related to end user devices or enterprise clients; an information parsing module that parses the data sets into a format suitable for insertion into a data storage device; an information analysis module that processes the parsed data sets to determine cost irregularities or opportunities to reduce telecommunications services expenses, wherein the information analysis module compares the cost of telecommunications services against one or more comparators such as expected usage, historical usage, cost overruns, roaming charges, benchmarking data, usage by other users, or internal policies; a negotiation module that, in response to receiving a request to change a telecommunications service, communicates proposed service request modifications based on the processed parsed data sets and the one or more comparators; an offer comparison module that receives one or more offered plans in response to the proposed service requests, and automatically compares the offered plans against the plans and the costs of telecommunications services; and a user interface that interfaces with an external network to provide an electronic portal to receive and transmit data from services providers, one or more end user devices, one or more enterprise clients, and one or more third party dealers.

In another embodiment, there is provided a non-transitory computer readable medium with computer readable-instructions which, when executed by one or more processors of a computing device, cause the one or more processors to be configured to for receiving, parsing, storing, analyzing and displaying information related to telecommunications services by:
receiving one or more data sets containing account and plan information for one or more end users;
processing the one or more data sets containing account and plan information to generate a set of recommendations;
transmitting electronic notifications to solicit offers from one or more third party suppliers and one or more telecommunications services providers; and
providing an interface on a display device of the one or more data sets containing account information, plan information, and recommendations, the interface also configured to receive instructions from an enterprise client or an end user.

In this respect, before explaining at least one embodiment in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

In the drawings, embodiments are illustrated by way of example. It is to be expressly understood that the description and drawings are only for the purpose of illustration and as an aid to understanding, and are not intended as a definition of the limits of the invention.

FIG. 1 is an illustrative diagram providing example computer hardware and software implementation of certain aspects, as detailed in the description.

FIG. 2 is a system diagram illustrating the components of the telecommunications services expense management platform and system, in one representative implementation thereof as an exemplary system diagram in accordance with embodiments.

FIG. 3 is an exemplary flow chart of the process involved with received receiving information, collating and parsing information, populating information, analyzing information, negotiating for offers, comparing offers and monitoring the implementation of recommendations, in accordance with embodiments.

FIG. 4 is an exemplary flow chart of the operation of the system, in accordance with embodiments.

FIGS. 5-16 are various sample user interface (UI) configured for display on screens of display devices illustrating the user interface, in accordance with embodiments.

### DETAILED DESCRIPTION

Embodiments, in one aspect, provide methods, systems, and computer products for managing expenses incurred for telecommunications services.

In some embodiments, the system may be designed as a telecommunication bill analyzer-optimizer, the technology being used to process, analyze and optimize costs for a variety of different users, as noted below.

Telecommunication services may include services such as telecommunications device hardware, mobile telephony services, landline telephony services, voice over internet protocol services, broadband internet services, mobile internet services, television services, among others.

In one embodiment, the system enables the management of telecommunications services expenses by providing a platform for determining telecommunications services cost savings as well as for account optimization based upon the needs of the end users.

In this example embodiment, the system collects electronic data about telecommunications services costs, usage and plans; processes and analyzes this data and creates a summary of key parameters for negotiations and reporting purposes; flags significant variations and decision points in cost and usage patterns to aid in negotiations with telecom service providers (e.g. using an electronic flag field in a data structure record for the electronic costs, usages, and plans data); produces a data set of recommended telecommunications plans to optimize telecommunications services cost savings, and provides an online web portal to allow the updating of service requirements, the web portal also displaying reports/summaries to aid management decision making. The specific system can be customized to meet the specific decision making and reporting demands of various enterprise clients, end users, telecommunications services providers and/or third party services providers. The system interacts with enterprise and client devices and backend systems for data and control command exchange via network infrastructure.

The system is designed for ease of use that would allow all parties involved (e.g. telecommunications services providers, third party suppliers, enterprise clients and end users) to relieve the pressure and disorganization surrounding day-to-day telecommunications issues and requests. These parties would have a much easier relationship with one another using a system that has been designed with the needs of all parties (especially the end user's) in mind, rather than the current fragmented systems and interfaces.

In one embodiment, enterprise clients or end users are provided access to the system through a web portal or a mobile application or an enterprise application. The enterprise clients or end users would be able to make requests to change their telecommunications services through the web portal or the mobile application via request commands transmitted to system. For example, an enterprise client or end user would be able to access the system through the internet, view summaries of information related to the accounts they manage, and initiate service changes through the web portal or the mobile application by transmitting change request commands.

In one embodiment, telecommunications services suppliers and third party suppliers may be able to access the system as part of their service to clients.

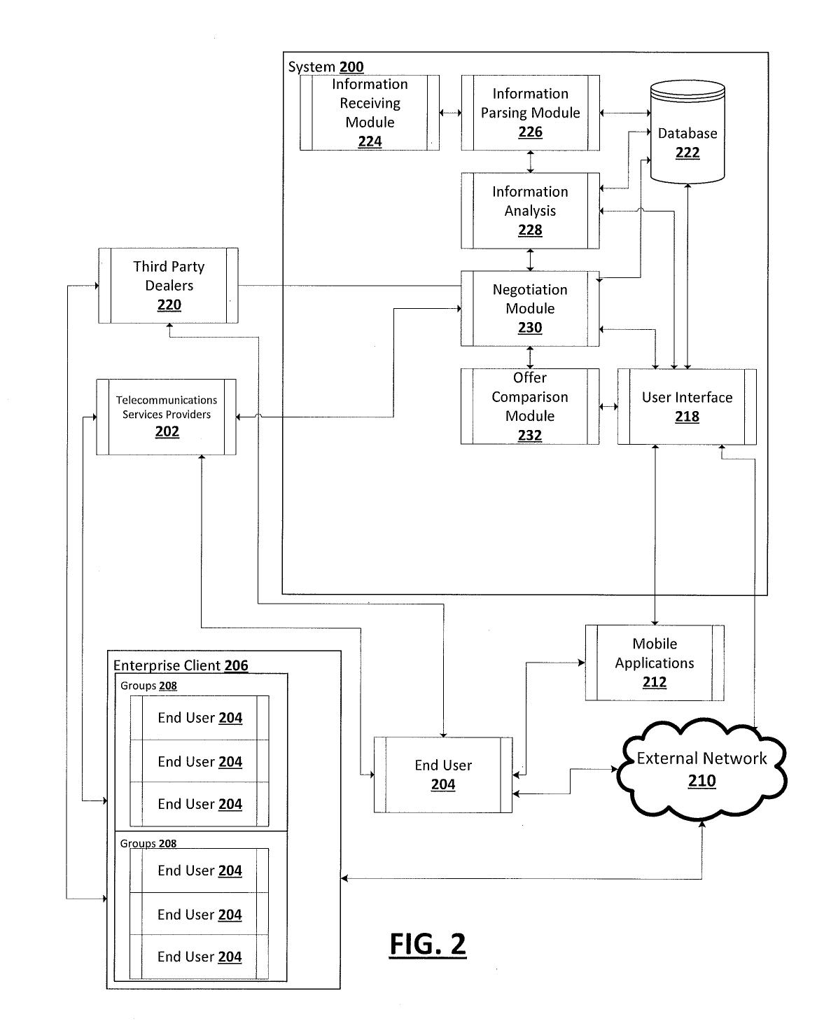

FIG. 2 illustrates an exemplary schematic diagram of a system in accordance with an aspects of various embodiments. The system 200 may be used to manage telecommunications services and expenses by interfacing with one or more telecommunications services providers 202, one or more end user devices 204, one or more enterprise clients 206, and one or more third party dealers 220.

The one or more telecommunications services providers 202 may include companies that provide telecommunications services either directly or indirectly to end user devices 204. For example, Verizon Communications Inc., Rogers Communications Inc., could be telecommunications services providers 202.

The one or more third party dealers 220 may provide telecommunications services related to hardware and hardware upgrades. For example, an independent dealer who has an inventory of iPhones and provides support for the devices would be a third party dealer 220. These services may also be offered by one or more telecommunications services providers 202.

The one or more end user devices 204 may be operated by users or individuals who utilize telecommunications services. Each end user 204 may use some, or all, of the telecommunications services offered by the one or more telecommunications services providers 202.

The one or more enterprise clients 206 are related to organizations who work with telecommunications service providers to provide services to groups of end users whose accounts may be managed by administrators working with an enterprise client 206. For example, a company managing telecommunications services accounts for 500 employees could be considered an enterprise client 206 with 500 end users 204.

An enterprise client may also segment its end users into one or more groups 208. For example, a company may wish to segment its telecommunications services accounts for the 200 end users 204 in the sales department separate from the 300 end users 204 in the finance department. Each segmentation could be a separate group 208.

The system 200 may include an information receiving module 224, an information parsing module 226, an information analysis module 228, a negotiation module 230, an offer comparison module 232, and a user interface 218.

The information receiving module 224 receives information in the form of account information and plan information related to end users 204 or enterprise clients 206. Information may be received in many different formats. Example formats may include .csv files, outputs from web portals, .xml files, .xls files, .pdf files, scanned hard copy files, and hard copy invoices. Information may be on a periodic basis or upon the occurrence of an event. For example, information may received as a result of adding an end user 204, or polled on a monthly basis from end users 204, from third party dealers 220 or from telecommunications services providers 202.

In the illustrated embodiment, the account information and plan information is provided by third party dealers 220 and telecommunications services providers 202.

In another embodiment of the invention, the account information and plan information may also be provided by directly by the enterprise clients 206 or the end users 204.

The information parsing module 226 receives information from the information receiving module 224 and parses the information into a format suitable for insertion into a database 222. The information parsing module transmits this parsed information into the database 222.

The information analysis module 228 analyzes the parsed information to determine cost irregularities or opportunities to reduce telecommunications services expenses. The information analysis module 228 may compare the cost of telecommunications services against expected usage, historical usage, cost overruns, roaming charges, benchmarking data, usage by other users, internal policies, among other comparators.

The negotiation module 230 uses the analyzed information from the information analysis module 228 as a basis for negotiations. The negotiation module 230 may be invoked when the user interface 218 receives a request to change a telecommunications service. The negotiation module 230 communicates between the third party dealers 220 and the telecommunications services providers 202. The negotiation module 230 submits service requests to the third party dealers 220 and telecommunications services providers 202, and receives offered plans in return from third party dealers 220 and telecommunications services providers 202.

The offer comparison module 232 compares the offered plans against the current plans and costs incurred by the end user 204. Different methods of comparing may be comparisons on a line-by-line cost basis, or comparisons on a feature-by-feature basis. The offer comparison module 232 communicates the comparison of the offered plans to the user interface 218.

The user interface 218 may interface with an external network 210 to administer and manage the system 200. The user interface 218 may also interface with one or more mobile applications 212 to administer and manage the system 200. For example, the external network 210 could be the Internet or a web portal located in the intranet of an organization, and the one or more mobile applications 212 could be applications built on smartphone operating systems or regular phones to allow them to interface with the system 200. The user interface 218 provides administrative interfaces to an administrator, which may be an end user 204 or an administrator for the enterprise client 206. The user interface 218 may provide different levels of administrative permissions and rights to different administrators. Examples of administrative and management activities available to administrators includes viewing summary reports, viewing individual account details, viewing a savings summary, viewing a cost breakdown, viewing plan overviews, viewing plan databases, viewing client invoices and submitting requests. Different levels of administrative permissions and rights may also be given to administrators using the web portal in the external network 210 and administrators using mobile applications 212.

In an embodiment, the mobile applications 212 (e.g. an example electronic portal) may communicate with the system 200 to notify that an end user 204 has travelled with their mobile device, and to provide the ability to select and apply service requests (e.g. adding a roaming package).

In another embodiment, the mobile applications 212 may have the ability to block automated messages from telecommunications suppliers (e.g. an automatic message that occurs when an end user 204 enters the United States stating “We noticed you are roaming. Visit m.fido.ca to purchase a roaming package”).

The user interface 218 may be used by the system 200 to request and communicate approvals, change requests, offers, commands, data sets, and so on. In some examples, electronic approval notifications are necessary prior to the enactment or generation of an electronic notification for a service request or change. Approvals may be necessary, for example, where a division manager must approve or reject requests prior to the requests being submitted to the one or more telecommunications providers 202.

In an embodiment, the user interface 218 may be used by different groups of individuals, such as end users 204 or administrators within the enterprise clients 206. Different groups of individuals may be provided different levels of administrative rights and permissions. For example, a group administrator may have the ability to request services changes without first obtaining approval, but an end user 204 may have to first require approval before sending out a service request.

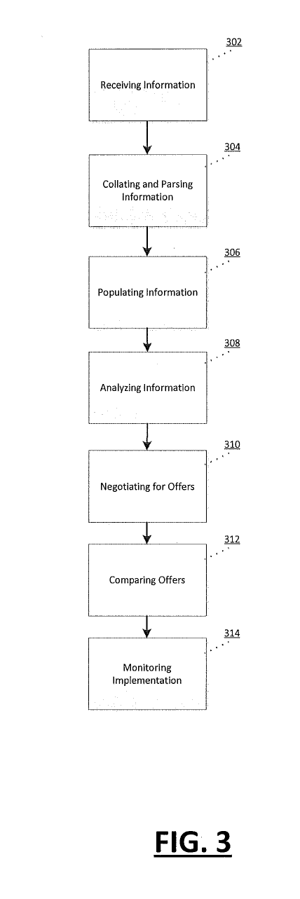

Referring now to FIG. 3, according to one embodiment, FIG. 3 illustrates a flow chart of the automatically onboarding data for an end user device 204 and monthly data collection on to the system 200, which may comprise of the steps of receiving information 302, collating and parsing information 304, populating information 306, analyzing information 308, negotiating for offers 310, comparing offers to existing services to generate recommendations 312 and monitoring the implementation of recommendations 314 using various hardware and software components, such as those described in relation to FIG. 2.

In the receiving information step 302, information regarding the telecommunications services provided to an end user 204 is transmitted to the system 200. The information may be transmitted both electronically or manually, in various formats. The information may be generated from one or more one or more telecommunications services providers 202. For example, the information could be provided as portable document format files (PDF), comma-separated values (CSV), Microsoft Excel documents, extensible markup language (XML), hypertext markup language (HTML) or simply physical copies of bills and/or invoices.

In an embodiment, the information received could also include upcoming travel behavior, past travel behavior, expected future data consumption, expected future roaming behavior, past roaming behavior, expected future usage.

Further, the information may also be obtained through the client or directly from the telecommunications services provider 202 through online website portals provided the telecommunications services providers' 202 online website portal.

In an embodiment of the invention, an application programming interface (API) is associated with one or more telecommunications services providers 202. The application programming interface could, for example, be an interface that communicates with the billing platforms of a telecommunications services provider 202. Examples of billing platforms include the Amdocs Customer Experience Systems (CES) and Intec's Singl eView systems.

In another embodiment of the invention, information may also be received through the user interface 218, where it is input by an administrator for an enterprise client 206 or an end user 204.

In the collating and parsing information step 304, the following information may be extracted from the received information: historic usage charges (e.g. number of minutes used, number of text messages sent, amount of data used, time of use, roaming charges incurred, long distance charges incurred, plan overage costs), service plan information details (e.g. plan include features, additional services [e.g. my5, voicemail, call display], associated costs, costs for overage, terms of contracts, duration of contracts, hardware subsidies), hardware information details (e.g. device used, subscriber identity module [SIM] number, international mobile station equipment identity [IMEI] number, upgrade eligibility, firmware version).

In an embodiment, the extracted information may be stored in a CSV file.

In the populating information step 306, the extracted information may be uploaded into a database 222 (at a data storage device), mapped by columns into specific fields. The data may be transformed to correspond to data records of database 222 for ease of comparison and further processing. For example, the fields may be defined to record different elements of the data for the purpose of system operations and may be linked to specific fields in the database (e.g. Daytime_Minutes_c, Type_of_Device_c).

In the analyzing information step 308, the extracted information is analyzed using decision rules to determine cost savings by identifying irregularities and cost overages (e.g. if daytime minutes exceeds daytime allowance then apply a new package or if US roaming charges are excessive then apply appropriate package). This analyzed information is available through the user interface 218.

In the negotiating for offers step 310, the analyzed information is used as a benchmark for negotiations with the one or more telecommunications services providers 202. Negotiations may occur through verbal negotiations using the analyzed information.

The negotiations may occur through direct interaction with the telecommunications services providers 202 via email, telephone or in person.

In an embodiment, the negotiations (e.g. electronic notification messages and change requests) may also be communicated through an API with a telecommunications services provider.

Based on the negotiations, the telecommunications services providers 202 may provide an electronic notification defining an offer for telecommunications services, and the electronic offer would be communicated to the system 200.

In the comparing offers step 312, the system 200 compares the extracted information from step 306 with the offer received in step 310, and may compute an analysis of telecommunications services usage (e.g. a line-by-line analysis), costs and recommendations for changes to service plans with the associated projected savings figures (e.g. the system produces a complete set of new plans to optimize telecommunications cost savings). The projected plans are communicated through user interface 218 and then reviewed and selected or modified by the enterprise client or the end user device as control or request commands.

Depending on the permissions and rights granted to the enterprise client 206 or the end user 204, the user interface 218 may first require an electronic notification approval from an approving authority. The electronic notification approval may be validated using digital certificates or signatures, in accordance with embodiments. An approving authority, may be a respective division manager. This division manager would have to approve or reject a communicated request message, prior to an approved request being submitted to the one or more telecommunications services providers 202. For example, Joe Smith may use the user interface 218 to request a hardware upgrade, but would first need approval from his team lead prior to submitting the service request to the telecommunications services provider 202.

Selected plans are implemented by communicating with the telecommunications services provider 202.

In the monitoring implementation step 314, pricing may of plans may be periodically and automatically compared to the offer that is input into the system. For example, the system may compare the monthly rates to those of the contracted offer and may alert an administrator, a user, or a third party, when or if there are differences in services and pricing.

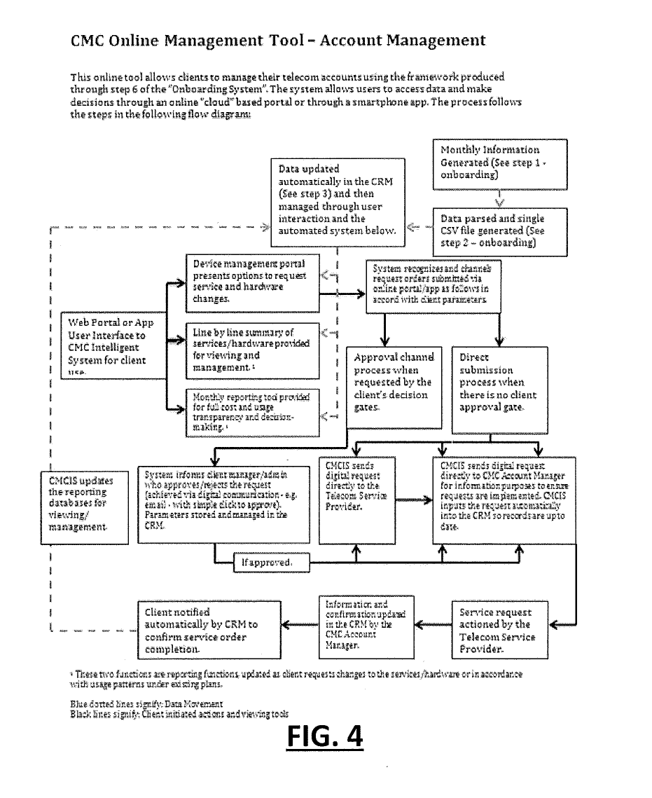

Referring now to FIG. 4, a sample data flow chart is provided, according to one aspects of embodiments described herein, that illustrates an example process where, broadly stated, account and plan information is received, parsed and extracted; the information is analyzed for cost savings opportunities; the options are electronically presented to the end user 204 or to the enterprise client 206; the end user 204 or the enterprise client 206 provides user interaction commands at interface to select one or more options and request orders to be submitted; the approval process for receiving an electronic notification for an order, if one exists; the communication of the service request to the telecommunications services provider 202; and the updating of the database on data storage device with the updated information. The example operations detailed in FIG. 4 may be implemented by various hardware and software components shown in FIG. 2, for example.

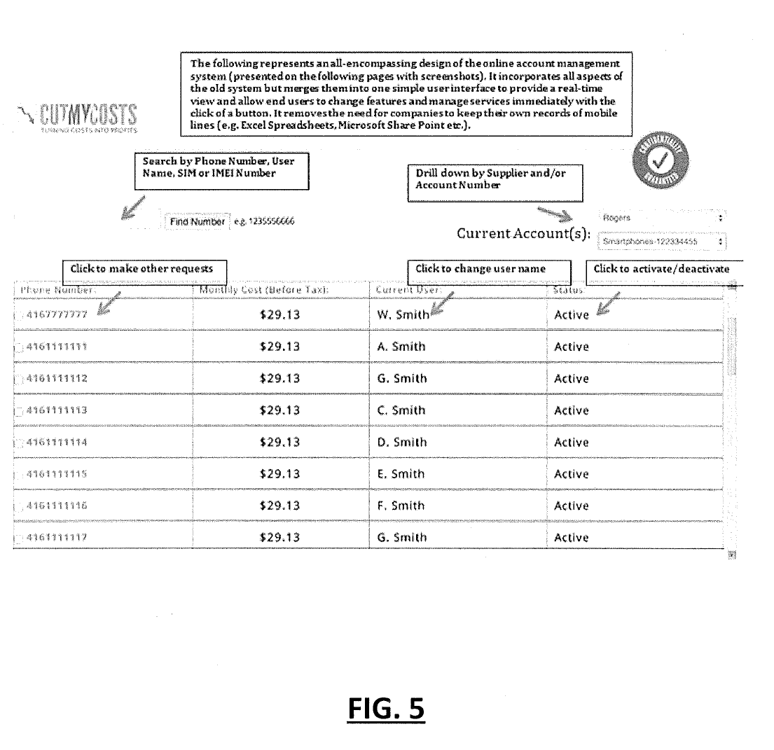

FIGS. 5-15 illustrate various sample user interface (UI) screens based on the user interface 218, according to one or more aspects of embodiments. The example UI screens are shown based on the web portal, but may also be shown in an adapted format for use with mobile applications 212.

FIG. 5 is an exemplar UI screen of the online account management system, where an administrator has an overview of various phone numbers under administration, the costs associated with those phone numbers, the users, and their status. The administrator is also able to conduct searches based on, for example, phone numbers, user names, SIM numbers, and IMEI numbers, or browse accounts based upon telecommunications services providers 102 or account numbers. The annotations indicate areas where an administrator can interface with the system to obtain more information or interact with a specific element on the screen.

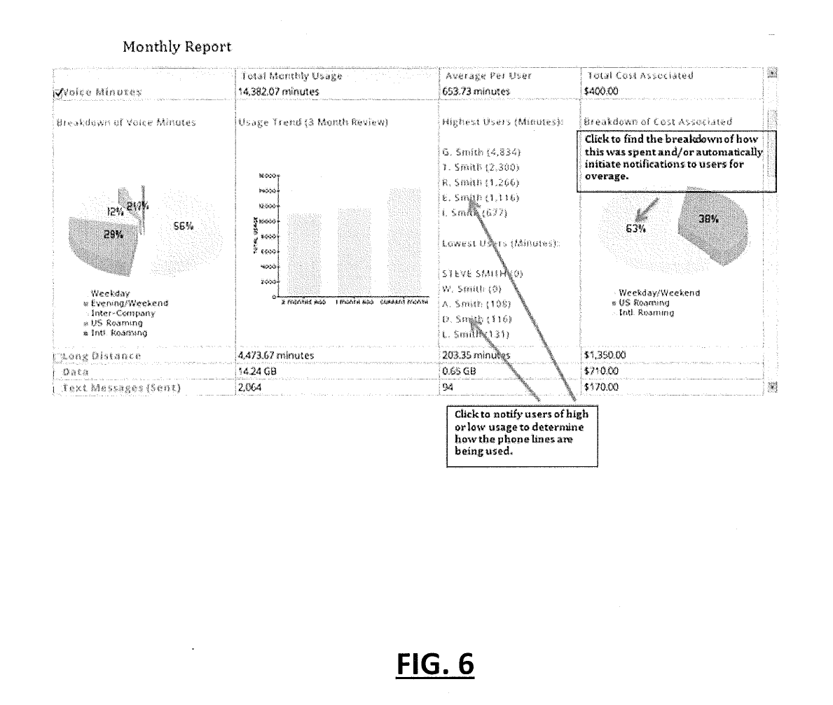

FIG. 6 is an exemplar UI screen of the online account management system, where an administrator is provided with a report containing summaries of voice minutes usage, usage trends, total monthly phone usages, average number of minutes used, total cost associated with the services, a listing of the highest users, a listing of the lowing users, a breakdown of the associated costs (e.g. by weekend/weekday minutes, US roaming, international roaming). The annotations indicate areas where an administrator can interface with the system to obtain more information or interact with a specific element on the screen. For example, administrator could choose to notify users of high or low usage in determining how the phone services are being used.

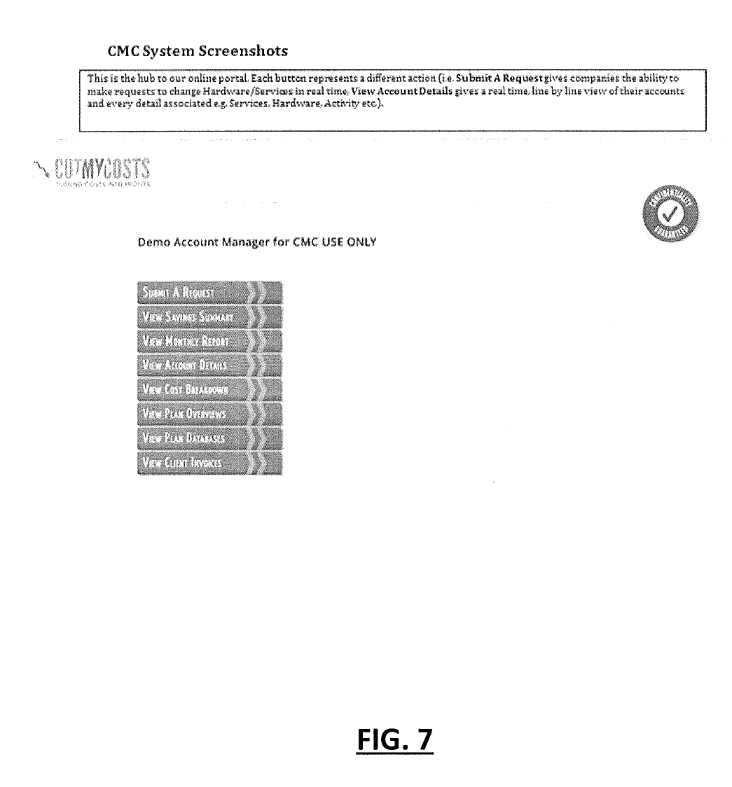

FIG. 7 is an exemplar UI screen of the online account management system, where an administrator is provided with options for account administrations. For example, “Submit a Request” would give an administrator the ability to make requests to change hardware or services, “View Account Details” would give a line by line view of their accounts and associated details (e.g. services, hardware, activity).

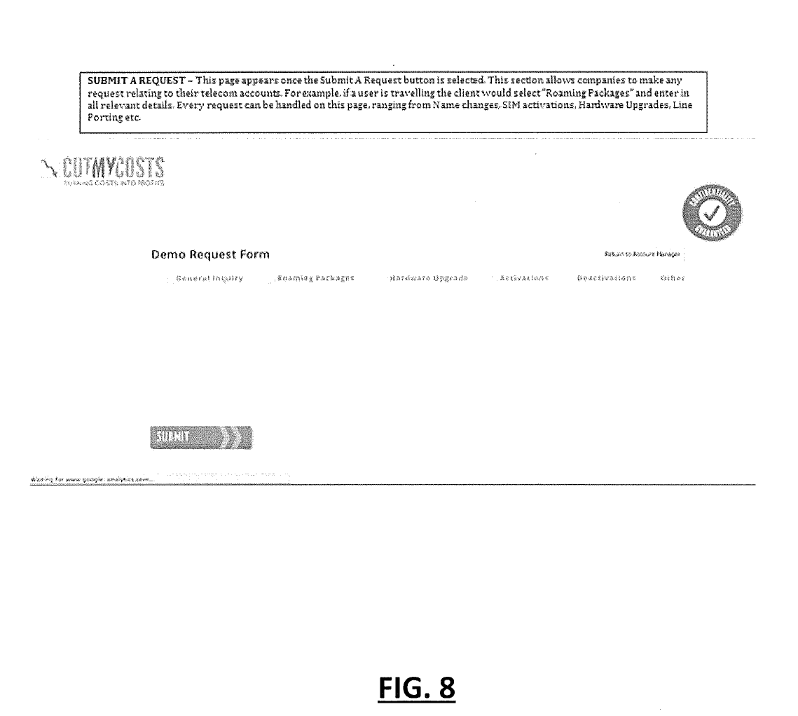

FIG. 8 is an exemplar UI screen of the online account management system, where an administrator is provided with a request form for submitting requests. The administrator, in this example, can choose between submitting a general inquiry, requesting roaming packages, hardware upgrades, activations, deactivations, or other requests. Other requests may also include name changes, line porting, etc.

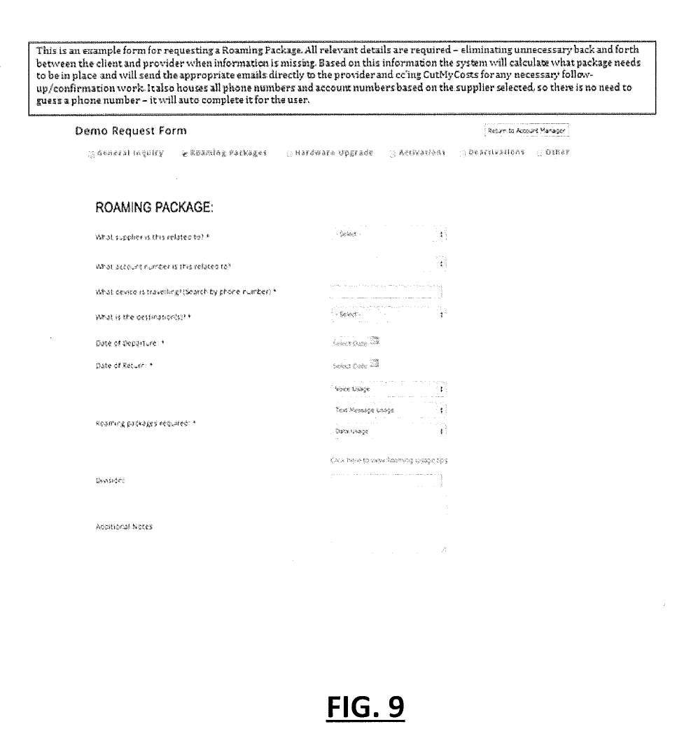

FIG. 9 is an exemplar UI screen of the online account management system, where an administrator is provided with a request form for requesting a roaming package. The request form allows the administrator to indicate the telecommunications services provider 102, the account number, which telecommunications service it is for, the destination, the date of departure, the date of return, the types of roaming packages required, the division of the service, and any additional notes. Upon submitting this information, the system may calculate the package that would be better suited for the usage and may also communicate with the telecommunications services providers and communicate with any third party if there is any follow up or confirmatory work required. The interface may also have the capability to automatically fill in any information that is stored on the databases (e.g. automatically filling out account numbers or phone numbers).

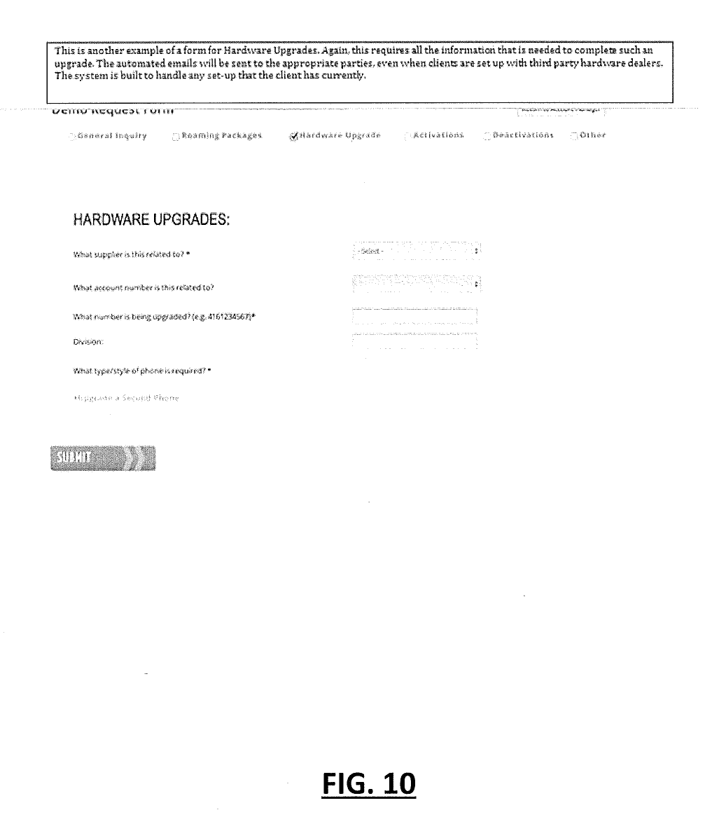

FIG. 10 is an exemplar UI screen of the online account management system, where an administrator is provided with a hardware upgrade form for requesting a hardware upgrade. This form would be used, for example, when an administrator would like to request a new iPhone for a specific user. The form may indicate the telecommunications services provider 202, the account number, which telecommunications service it is for, the division for the service, and what type of hardware is requested. Upon submitting this information, the system could communicate with the relevant parties for a hardware upgrade. Depending on the particular enterprise client 206 or end user 204, the relevant parties for a hardware upgrade may be a telecommunications services provider 202, or a third party hardware dealer 220.

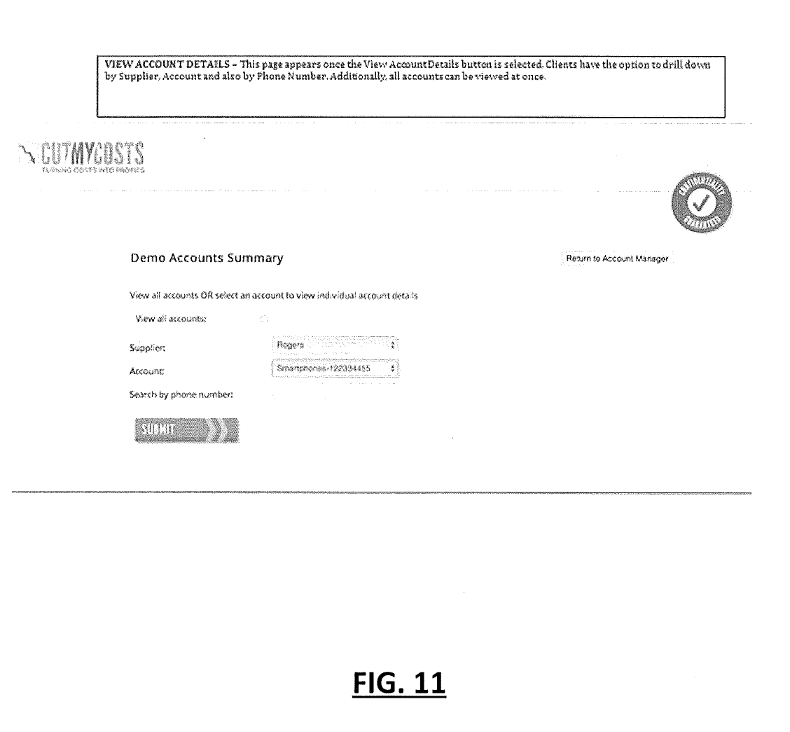

FIG. 11 is an exemplar UI screen of the online account management system, where an administrator is provided with a form to select accounts to be viewed. The administrator may select to view individual accounts or more than one account at once, and, in this example, segment by telecommunications services provider 202, account, or search by phone number.

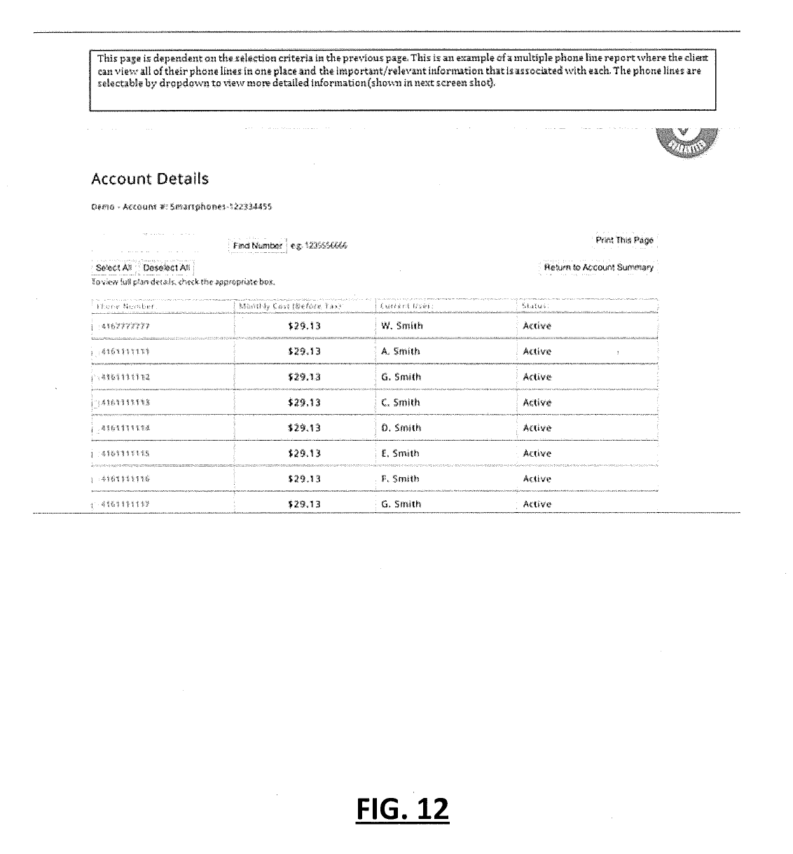

FIG. 12 is an exemplar UI screen of the online account management system, where an administrator is provided with an expanded view of account details for a service. The service illustrated is an example telephony plan. The administrator is able to view details related to the account, which may include features, services, hardware, status of activation, current user, costs, etc.

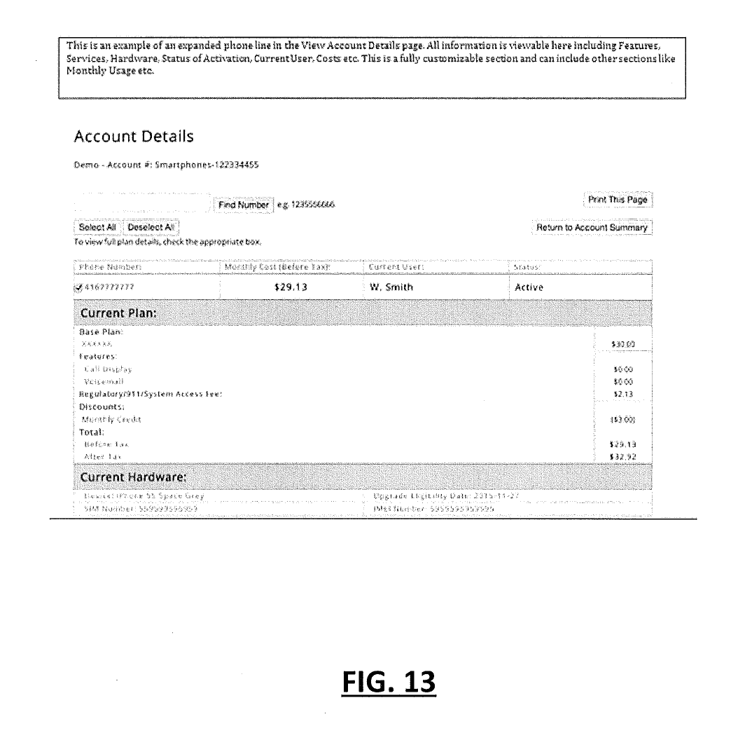

FIG. 13 is an exemplar UI screen of the online account management system, where an administrator is provided with a view of the account details. The administrator may select to view individual accounts or more than one account at once, and, in this example, segment by telecommunications services provider 202, account, or search by phone number.

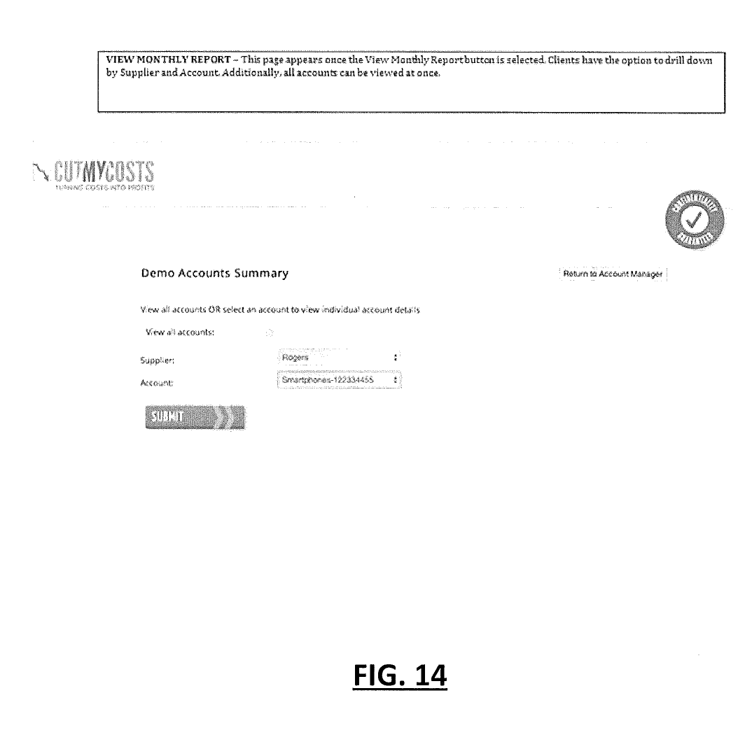

FIG. 14 is an exemplar UI screen of the online account management system, where an administrator is provided with a form to select accounts to be viewed. The administrator may select to view individual accounts or more than one account at once, and, in this example, segment by telecommunications services provider 202 and account.

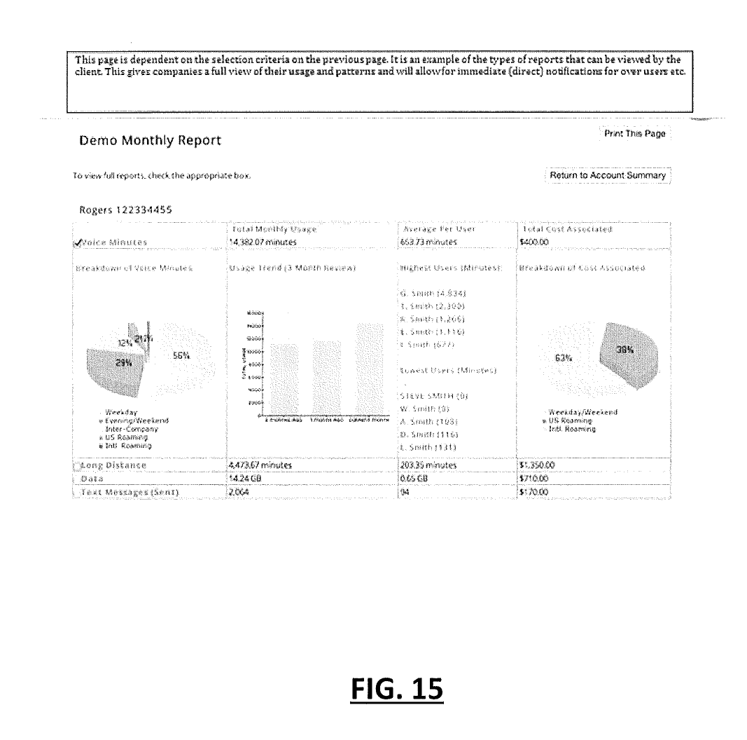

FIG. 15 is an exemplar UI screen of the online account management system where an administrator is provided with a report containing summaries of voice minutes usage, usage trends, total monthly phone usages, average number of minutes used, total cost associated with the services, a listing of the highest users, a listing of the lowing users, a breakdown of the associated costs (e.g. by weekend/weekday minutes, US roaming, international roaming). The annotations indicate areas where an administrator can interface with the system to obtain more information or interact with a specific element on the screen. For example, administrator could choose to notify users of high or low usage in determining how the phone services are being used. The information provided on this page is dependent on the selection criteria selected from FIG. 14.

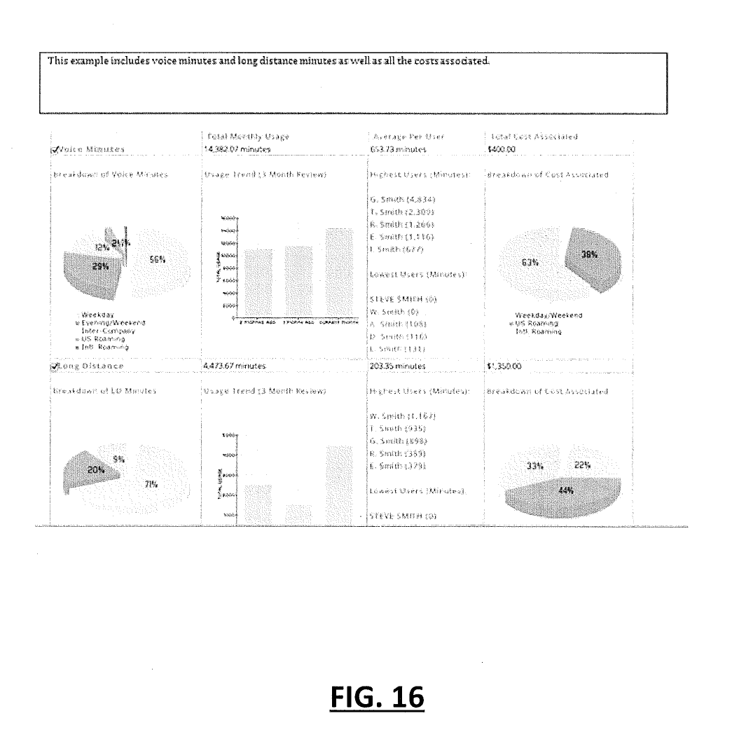

FIG. 16 is an exemplar UI screen of the online account management system illustrating a sample view where the long distance, voice minutes, and breakdown of costs sections are expanded in a monthly report.

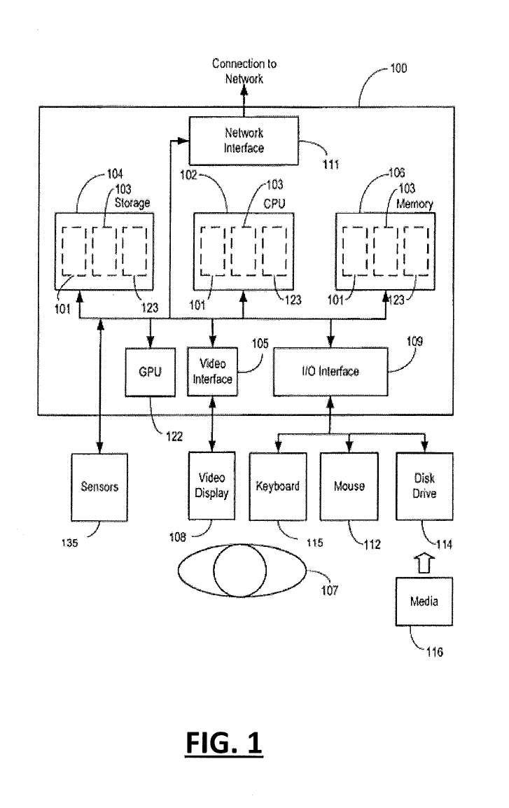

The present system and method may be practiced in various embodiments. A suitably configured computer device, and associated communications networks, devices, software and firmware may provide a platform for enabling one or more embodiments as described above. By way of example, FIG. 1 shows a computer device 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. Computer device 100 may further include a graphics processing unit (GPU) 122 which is operatively connected to CPU 102 and to memory 106 to offload intensive image processing calculations from CPU 102 and run these calculations in parallel with CPU 102. An operator 107 may interact with the computer device 100 using a video display 108 connected by a video interface 105, and various input/output devices such as a keyboard 115, mouse 112, and disk drive or solid state drive 114 connected by an I/O interface 109. In known manner, the mouse 112 may be configured to control movement of a cursor in the video display 108, and to operate various graphical user interface (GUI) controls appearing in the video display 108 with a mouse button. The disk drive or solid state drive 114 may be configured to accept computer readable media 116. The computer device 100 may form part of a network via a network interface 111, allowing the computer device 100 to communicate with other suitably configured data processing systems (not shown). One or more different types of sensors 135 may be used to receive input from various sources.

The present system and method may be practiced on various computer devices including a desktop computer, laptop computer, tablet computer or wireless handheld. The present system and method may also be implemented as a computer-readable/useable medium that includes computer program code to enable one or more computer devices to implement each of the various process steps in a method in accordance with the present invention. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

The mobile application of the embodiments may be implemented as a web service, where the mobile device includes a link for accessing the web service, rather than a native application.

The functionality described may be implemented to different mobile platforms, including the iOS™ platform, ANDROID™, WINDOWS™ or BLACKBERRY™.

It will be appreciated by those skilled in the art that other variations of the embodiments described herein may also be practiced and other modifications are therefore possible.

In further aspects, the disclosure provides systems, devices, methods, and computer programming products, including non-transient machine-readable instruction sets, for use in implementing such methods and enabling the functionality described previously.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

### Illustrative Example Applications

The following examples are non-limiting and are provided solely for illustrative purposes.

The system may be applied to provide automated or semi-automated cost analyzer-optimizer and telecom cost analyzer-optimizer solutions for the potential benefit of a variety of users.

The system may aid the end users in finding plans that provide the right fit and to reduce their overall telecommunications spend by providing transparency and ease of access to information to support the decision making ability of users to negotiate and optimize their costs.

The system may also be of use for telecommunications services providers and/or third party hardware providers as they may offer the tool to customers to help them ‘right size’ their plans, and/or manage their overall spend.

A potential benefit of using the system may be the ability to forecast out the expected costs, which may be particularly advantageous for major companies who use the forecasts in determining their future budgets and spending allocations.

A potential ancillary benefit for telecommunications services providers is an increased level of trust between parties as the system helps develop a relationship where the parties understand that the telecommunications services are provided at a fair price.

The increased level of trust may potentially result in more services being consumed by the end users as the end user may be more confident that the prices they are receiving are not unreasonable relative to the current state of the market.

What is claimed is:

1. A backend server platform to manage telecommunications services and expenses that interfaces one or more telecommunications services providers, one or more end user devices, one or more enterprise clients, and one or more third party dealers, the server platform comprising:
an information receiving module that receives electronic data sets in the form of costs, accounts and plan for telecommunications services related to end user devices or enterprise clients;
an information parsing module that parses the data sets into a format suitable for insertion into a data storage device;
an information analysis module that processes the parsed data sets to determine cost irregularities or opportunities to reduce telecommunications services expenses, wherein the information analysis module compares the cost of telecommunications services against one or more comparators such as expected usage, historical usage, cost overruns, roaming charges, benchmarking data, usage by other users, or internal policies;
a negotiation module that, in response to receiving a request to change a telecommunications service, communicates proposed service request modifications based on the processed parsed data sets and the one or more comparators;
an offer comparison module that receives one or more offered plans in response to the proposed service requests, and automatically compares the offered plans against the plans and the costs of telecommunications services; and
a user interface that interfaces with an external network to provide an electronic portal to receive and transmit data from services providers, one or more end user devices, one or more enterprise clients, and one or more third party dealers.

2. The platform of claim 1 wherein the electronic portal comprises a mobile application or web portal.

3. The platform of claim 1 wherein the user interface provides a mobile application on an end user's mobile device and is configured to determine whether the mobile device is roaming, and if the device is roaming, apply a set of instructions to the mobile device, and collect cost and usage data from the mobile device.

4. A system for receiving, parsing, storing, analyzing and displaying information related to one or more telecommunications services is provided, the system comprising:
at least one module configured to receive one or more data sets containing account and plan information for one or more end users;
at least one module configured to analyze the one or more data sets containing account and plan information to generate a set of recommendations;
at least one module configured to solicit offers from one or more third party suppliers and one or more telecommunications services providers; and
at least one module configured to provide an interface to display the one or more data sets containing account information, plan information, and recommendations, wherein the at least one module is also configured to receive instructions from an enterprise client or an end user.

5. The system of claim 4, wherein the at least one module configured to provide an interface to display the one or more data sets and to receive instructions includes a web portal.

6. The system of claim 4, wherein the at least one module configured to provide an interface to display the one or more data sets and to receive instructions includes a mobile application.

7. The system of claim 4, wherein the at least one module configured to receive one or more data sets containing account and plan information receives information by interfacing with the one or more telecommunications services provider's backend systems.

8. The system of claim 6, wherein the mobile application is configured to determine whether an end user's mobile device is roaming, and if the device is roaming, apply a set of instructions to the mobile device.

9. The system of claim 6, wherein the mobile application is configured to receive input data from an end user that specific telecommunications expenses should be passed on to a third party.

10. The system of claim 4 further comprising at least one module for parsing the data sets into a format suitable for insertion into a data storage device and extracting plan, usage and cost data for telecommunication services.

11. The system of claim 4 further comprising at least one module for processing the parsed data sets to determine cost irregularities or opportunities to reduce telecommunications services expenses.

12. The system of claim 11 wherein the at least one module for processing is configured to compare the cost of telecommunications services against one or more comparators such as expected usage, historical usage, cost overruns, roaming charges, benchmarking data, usage by other users, or internal policies;

13. The system of claim 4 further comprising at least one module that, in response to receiving a request to change a telecommunications service, communicates proposed service request modifications based on processed data sets and one or more comparators.

14. The system of claim 4 further comprising at least one that receives one or more offered plans in response to the proposed service requests, and automatically compares the offered plans against plans, usage and costs of telecommunications services.

15. The system of claim 4 wherein the at least one module configured to provide an interface generates and provides an interface for online account management collating data from all user accounts from multiple service providers along with an account identifier, cost data and status data for each user account.

16. The system of claim 4 wherein the at least one module configured to provide an interface generates and provides an interface for a periodic report include a summary of total usage for a defined period, average usage for the defined period, average usage per user for the defined period, and total costs for the defined period.

17. The system of claim 4 wherein the at least one module configured to provide an interface generates and provides an interface for defining a change request to trigger offers.

18. A method for automatically onboarding data for an end user device and period data collection:
receiving data sets defining data related to telecommunication services;
collating and parsing the data sets to extract plan, usage and cost data for telecommunication services;
populating a data storage device with the plan, usage and cost data;
processing and analyzing information using decision rules managed by a rules engine processor to determine cost savings by identifying irregularities and cost overages;
automatically negotiating for offers by comparing one or more received electronic offers for telecommunications services to existing services to automatically generate recommendations;
transmitting notification of selected telecommunications services based on the recommendations; and
electronically monitoring the implementation of selected telecommunications services by collecting and processing additional data sets for the telecommunications services.
